(19) United States
(12) Patent Application Publication
(10) Pub. No.: US 2014/0008300 A1
(43) Pub. Date: Jan. 9, 2014

(54) SEPARATION PROCESS BY MEANS OF HIGH FLOW CONTINUOUS CHROMATOGRAPHY AND CORRESPONDING DEVICE

(71) Applicant: Nicolas Fauquet, Saint Leu La Foret (FR)

(72) Inventor: Nicolas Fauquet, Saint Leu La Foret (FR)

(21) Appl. No.: 13/884,531

(22) PCT Filed: Oct. 31, 2011
(86) PCT No.: PCT/FR2011/052549

§ 371 Date: Jul. 22, 2013

(30) Foreign Application Priority Data
Nov. 9, 2010 (FR) 1004383

(51) Int. Cl. B01D 15/10

(52) U.S. Cl. CPC B01D 15/10
USPC 210/656; 210/198.2

(57) ABSTRACT

A method and device are provided for separating fractions of a mixture that is to be separated by liquid phase chromatography. The method includes the steps of: multiple injections of the mixture to be separated, where the injections are made successively into a chromatography column after time intervals A; multiple decanting operations, wherein the fractions of said column are decanted successively after time intervals A, generating an eluate enriched with the fraction of interest, which is created from at least one of said decanted fractions; multiple injections of the eluate collected in the preceding step, wherein the injections of the eluate are carried out successively after time intervals B into a second chromatography column; and multiple decanting operations, wherein the fractions from said second column are decanted successively after time intervals B.

### CROSS-REFERENCE TO RELATED APPLICATIONS

This Application is a Section 371 National Stage Application of International Application No. PCT/FR2011/052549, filed Oct. 31, 2011, which is incorporated by reference in its entirety and published as WO 2012/062985 on May 18, 2012, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The invention relates to a method for separating fractions of a mixture by liquid phase chromatography, also referred to by the shorter name liquid chromatography.

It should be noted that, for the purposes of the present invention the term liquid chromatography designates a variety of techniques such as high-performance liquid phase chromatography, low pressure liquid phase chromatography, open column liquid phase chromatography, subcritical water chromatography, supercritical water chromatography, centrifugal partition chromatography (CPC) and similar techniques.

### BACKGROUND

Liquid phase chromatography is a method for separating the constituents of a mixture. It relies on the different affinities of the various constituents of the mixture for the same system through which they pass.

This system comprises a stationary phase and a mobile phase, which may be of very different natures.

This principle is used very widely, particularly in industrial and laboratory applications in order to purify different products of interest or to eliminate one specific impurity.

One drawback to the various procedures that are used in particular to process high volumes is the discontinuous nature of these very procedures. Attempts to address this problem include the use of batch systems, the simulated mobile bed, use of multiple columns in parallel or in series, and others. These known procedures are in turn associated with difficulties in that they are extremely complex in terms of connections, pumps and valves since they entail moving the injection points into the various columns used, or changing flow directions inside the columns.

Another known approach involves the use of gradients, and is effective in shortening the time between two injections into one column but presents other problems, one of which is that it requires a longer balancing phase between two injections and the use of more complex solvent mixtures.

### SUMMARY

The invention relates to a method for separating fractions of a mixture to be separated using liquid chromatography.

To this end, a method is suggested comprising the steps of:
multiple injections of the mixture to be separated: the injections are made successively into a chromatography column after time intervals A,
multiple decanting operations: the fractions of said column are decanted successively after time intervals A, generating an eluate enriched with the fraction of interest, which is created from at least one of said decanted fractions,
multiple injections of the eluate collected in the preceding: the injections are carried out after time intervals B in a second chromatography column,
multiple decanting operations: the fractions from said second column are decanted successively after time intervals B.

It should be noted that, for the purposes of the present invention the term “eluate” refers to an enriched product that contains at least of one of said fractions. Consequently, the term “eluate” does not have to be limited to the result of the elution.

In particular, the collected eluate may be formed by a single fraction or more than one fraction. Moreover, the number of fractions that make up the eluate may vary over time.

In a particular embodiment of the invention, the eluate is formed from all of the fractions decanted from the first column.

In another particular embodiment of the invention, the eluate collected may be obtained by selecting some of the fractions decanted from the first column.

A variant of this method consists in that A and B are set to values such that the successive injections are carried out even before elution of the product of interest has begun.

A variant of this method consists in that A and B are set to values that remain constant over time.

A variant of this method consists in that A and B are set to values that remain constant over time and are defined such that A and B are not integer multiples of one another.

A variant of this method consists in that the values of A and/or B are changed between each injection.

A variant of this method consists in that the values of A and/or B are changed during the procedure according to a protocol common to all of the injection and decanting steps for one column.

A variant of this method consists in giving A and B values such that they are not integer multiples of one another.

A variant of this method consists in reusing the first column in place of the second column.

In a particular embodiment of the invention, it may be provided to concentrate the eluate that has been generated before it is injected in the second column.

A rotary evaporator, from the Rotavapor (registered trade mark) product line for example, and/or a device such as a cartridge or a column capable of sequestering (by adsorption for example) and then releasing the products of interest again, may be used to this end.

A variant of this method consists in allocating a detector in series or in parallel to the decanting devices.

A variant of this method consists in using a second column with a cross section that is approximately equal to a significant multiple of the cross section of the first column.

A variant of this method consists in injecting fractions depleted in product of interest into the device again.

A variant of this method consists in injecting fractions enriched in product of interest into the device again.

A variant of this method is that the eluted product is a product to be removed from the mixture.

A variant of this method consists in adding valves or devices that enable flushing, cleaning or pressure control in the columns.

A variant of this method consists in using this method over and over again.

A variant of this method consists in carrying out injections of the mixture to be separated cyclically.

A variant of this method consists in using assemblies of several columns instead of the first and/or second column.

A variant of this method consists in using a different elution system in the second column.

A variant of this method consists in using a pressure difference between the device inlet and outlet.

It is also suggested to use this method for separating or purifying synthetic molecules, natural products, proteins, immunoglobulin, peptides, ions, and the like.

One of the main advantages of this method is that it enables the mixture for separation (called “unit fractions” or “quanta” in the following text) to be injected into the same column multiple times even before elution of the fractions of interest has begun. Moreover, unlike other methods, the present invention tolerates a superposition of the migrating molecules that are injected at different times.

The injection and decanting sites are not necessarily shifted during the method.

The invention further relates to a device for separating fractions of a mixture for the implementation of any of the methods of separating fractions of a mixture described in the preceding.

According to the invention, such a device for separating fractions of a mixture comprises:
at least one chromatography column;
means for decanting a plurality of fractions from said chromatography column at controlled time intervals A and/or B;
means for injecting a mixture into said chromatography column at controlled time intervals A, and/or injecting an eluate into said chromatography column at controlled time intervals B, said eluate being formed from at least one of said decanted fractions;
means for collecting said plurality of decanted fractions from said chromatography column;
means for transferring said decanted fractions from said collecting means to said injection means.

The decanting means may particularly comprise one or more solenoid valves, and the injection means may comprise for example one or more injectors equipped with samplers controlled automatically by a computer terminal.

Moreover, fractions may be collected in any container, known cartridge or column (e) of any suitable shape and capacity. In an advantageous embodiment of the invention, said cartridge or column may be configured such that the product of interest may be trapped then released, particularly by the action of a solvent, in order to concentrate the eluate produced.

In a particular embodiment of said device for separating fractions of a mixture, the decanted fractions may be transferred by gravity and/or with the aid of a pump.

In addition, it may be provided in at least one particular embodiment of the invention for such a separation device to comprise a bypass pipe or “split”, arranged in parallel with the fraction decanting means and connected to a mass spectrometer in order to detect the instant at which the product of interest reaches the decanting means.

Such a device for separating fractions of a mixture preferably comprises means for synchronising said injections of the mixture and the eluate into said one or more chromatography columns.

In at least one particular embodiment of the invention, the separation device comprises a chromatography column into which said mixture is to be injected, and one chromatography column into which said collected fractions are to be injected, joined by at least transfer pipe for said fractions.

According to a particular aspect of the invention, said device for separating fractions of a mixture comprises means for concentrating fractions forming an eluate that are decanted from said one or more chromatography columns.

The concentration means may for example comprise one or more rotary evaporators and/or at least one device, such as a column or cartridge for example, that is capable of trapping (particularly by adsorption) the product of interest income to release it afterwards, particularly due to the action of an eluting solvent.

Said device for separating fraction of a mixture preferably comprises means for automatically controlling said injection means and/or said decanting means and/or said transfer means.

The control means may for example comprise at least one programmable logic controller.

In addition, a software application may be provided that enables the corrections to be made to the values of time intervals A and/or B in the event of a drift in elution time through the column to be predicted.

In a particular embodiment of the invention, a prior step of optimising the values of time intervals A and B, their variation over time, and injection durations depending on results of a calibration phase of the separation device is also conceivable. A computer software product downloadable from a communications network and/or stored on a computer readable medium and/or executable by a processor comprising program code instructions for executing this optimisation step when said program is executed by a computer, may thus be provided.

Other advantages of the invention will be evident upon reading the detailed descriptions provided in the following.

### BRIEF DESCRIPTION OF THE DRAWINGS

FIG. 1 is a diagram, which illustrates a method of separating implemented in a device that operates in two phases performed on two columns at the same time.

FIG. 2 is a diagram, which illustrates a variant of the method wherein the second column is different from the first.

FIG. 3 is a diagram, which shows a variant of the method wherein the first column and the second column are the same.

FIG. 4a is a diagram, which shows a variant according to which a time interval between two injections is fixed over time.

FIG. 4b is a diagram, which shows a variant according to which the time interval between two injections is not fixed over time.

FIG. 5 shows the content of a second chromatography column at different times from T0 to T0+n′B.

FIG. 6 is a diagram, which shows positions of fractions of the product of interest as they migrate in the column, during a first phase.

FIG. 7 is a diagram, which shows positions of fractions of the product of interest as they migrate in the column, during a second phase, wherein a part of the mixture obtained previously is injected into the column.

FIG. 8 is a graph, which shows a part of the chromatogram of the mixture to be separated.

FIG. 9 is a graph, which shows a superposition of the first three chromatograms of the co-migrating mixture in the same column.

### DETAILED DESCRIPTION OF ILLUSTRATIVE EMBODIMENTS

The general method according to the invention is to carry out multiple injections of the mixture to be separated into a column, without necessarily waiting for the product of interest to be eluted, nor even waiting until the group of molecules injected previously is no longer superimposed on the group that is injected afterwards.

Said multiple injections follow a first protocol which defines the value of A and the variations thereof over time, A is defined as the time interval between two successive injections and it can take several values Δt.

Fractions rich in product of interest are then collected using a decanting device at the end of the column that follows the same protocol as that of injection.

The eluate obtained thus contains a higher concentration of the product of interest than the initial mixture. But it is still mixed with impurities originating from other injections that migrate into the column.

These impurities that are co-eluted with the product of interest depend directly on the protocol used. (Thus, for the variant in which A is defined as a fixed value throughout the procedure, the co-eluted impurities have a retention time equal to that of the product of interest more or less in integer multiples of the value of A.)

After the operation on the eluate collected previously is repeated with a different injection and decanting protocol, the impurities are eliminated.

Multiple injections are performed again according to a new protocol that defines the value of B and its variations over time, B is defined as the time interval between two injections, it may take several values Δt.

The purified fractions are then collected with the aid of a decanting device at the end of the column that follows the same new protocol.

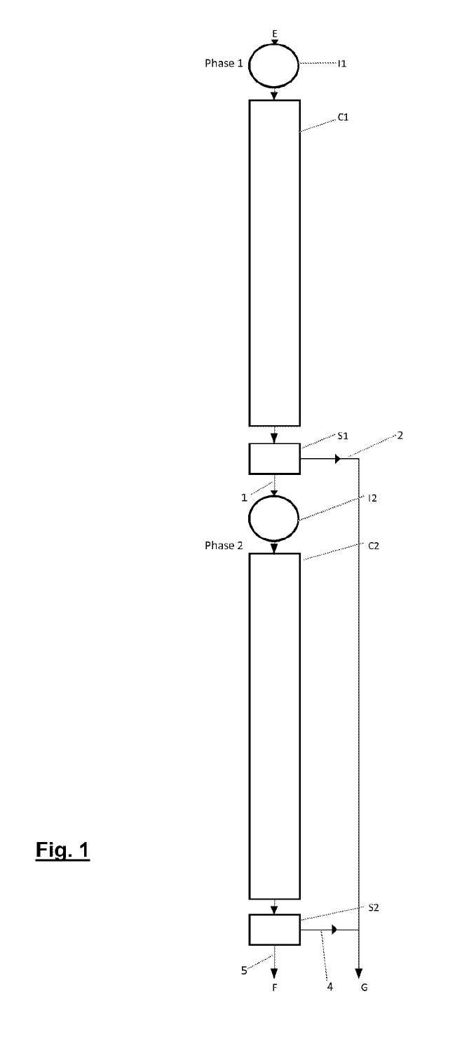

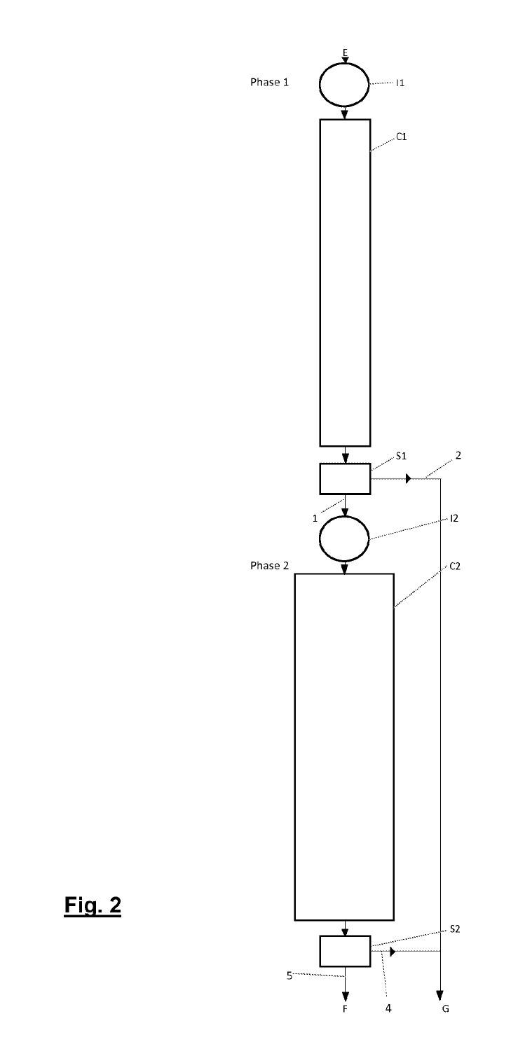

The inventive method is implemented in a device that operates in two phases, the two phases may be performed on the same column at two different times (FIG. 2), or on two columns at the same time (FIG. 1).
Phase 1: The device comprises an injector (I1), a chromatography column (C1) and a device for collecting fractions (S1). This part of the device fulfils the functions of multiple injections of the mixture to be separated into the device and collecting the enriched fractions in accordance with a defined protocol 1. Said protocol 1 prescribes the common rate for injections and decanting operations in Phase 1. The guidance of the injection and decanting operations according to the timing dictated by protocol 1 is advantageously assured via a software program for managing the function of the chromatography column (not shown in FIGS. 1 and 2).
Injections are carried out in succession after time intervals A, the variations in which are defined in protocol 1. The multiple decanting operations of the product of interest are then carried out successively after time intervals A, the variations in which follow the same protocol 1 as that of the injections. This results in the formation of an eluate that is rich in the fraction of interest.
Phase 2: The device comprises an injector (I2), a chromatography column (C2) and a device (S2) for collecting the fractions. This part of the device fulfils the functions of injections of the eluate obtained previously into the device and collecting the purified fractions in accordance with a defined protocol 2. Said protocol 2 prescribes the common rate for injections and decanting operations in Phase 2. The guidance of the injection and decanting operations according to the timing dictated by protocol 2 is advantageously assured via a software program for managing the function of the chromatography column (not shown in FIGS. 1 and 2)
The injections are carried out in succession after time intervals B, the variations in which are defined in protocol 2. The multiple decanting operations of the product of interest are then carried out in succession after time intervals B, the variations in which follow the same protocol 2 as that of the injections.

In the following, we will refer to the values taken by A or B, annotated with Δt as the time intervals between two successive injections, as the “injection frequency”.

FIG. 1 illustrates one of several ways in which the method is performed:
(I1) denotes injector number 1, which injects the mixture to be separated, leaving times A between each injection, the variations in which times are determined by a defined protocol (protocol 1).
(C1) denotes the first chromatography column in which the separation of the product of interest is carried out.
S1 denotes decanting device number 1, which collects the fractions of interest from column (C1) in accordance with the same protocol 1 as that of the injections (1), which are directed towards injector (I2). Outside of the periods in which the product of interest is eluted, the solvent stream containing the impurities to be eliminated (2) is directed towards the collector of fractions that cannot be used.
(I2) denotes injector number 2, which collects the fractions of interest recovered by (S1) and injects them into column (C2) in accordance with a second protocol (protocol 2) which sets the changes in the value of B over time.
(C2) denotes the second chromatography column in which the separation of the product of interest is carried out.
(S2) denotes decanting device number 2, which collects the fractions of interest from column (C2) according to the same protocol 2 as that of the injections (5). Outside of the periods in which the product of interest is eluted, the solvent stream containing the impurities to be eliminated (4) is directed towards the collector of fractions that cannot be used.
The arrows represent the flow of solvent.
Point (E) denotes the entry of the mixture to be purified, point (F) denotes the collection location of the purified fraction, and point (G) denotes the collector for fractions that cannot be used.

FIG. 2 shows a variant of the method wherein the second column is different from the first, in particular it may have larger or smaller dimensions than the first, or it may use a different elution system, or a solid phase.
In this variant, (I1) denotes injector number 1, which injects the mixture to be separated, leaving times A between each injection, which times are determined by a first defined protocol (protocol 1).
(C1) denotes the first chromatography column, in which the separation of the product of interest is carried out.
(S1) denotes decanting device number 1, which collects the fractions of interest from column (C1) according to the timing prescribed by protocol 1 (1). These fractions of interest are directed to injector (I2). Outside of the periods in which the product of interest is eluted, the solvent stream containing the impurities to be eliminated (2) is directed towards the collector of fractions that cannot be used.
(I2) denotes injector number 2, which collects the fractions of interest recovered by (S1) and injects them into column (C2) in accordance with a second protocol (protocol 2), which sets the variations in the value of B over time.
(C2) denotes the second chromatography column, in which the separation of the product of interest is carried out.
(S2) denotes decanting device number 2, which collects the fractions of interest from column (C2) according to the same protocol 2 as that of the injections (5). Outside of the periods in which the product of interest is eluted, the solvent stream containing the impurities to be eliminated (4) is directed towards the collector of fractions that cannot be used.
The arrows represent the flow of solvent.
Point (E) denotes the entry of the mixture to be purified, point (F) denotes the collection location of the purified fraction, and point (G) denotes the collector for fractions that cannot be used.

It should be noted that this variant is particularly advantageous when the cross section of the second column approaches the cross section of the first column by at least the multiple of B/A.

In fact, this makes it possible to maintain a constant flow of material: in the second column injections are B/A times less frequent than in the first column, so the second column may have a lower flow rate than the first column that feeds it. In order to avoid exceeding the storage capacities of injector (I2), it may be necessary to increase the volume injected into the second column by B/A. In particular by increasing the cross section of the second column by B/A. In this variant of the device, it is also possible to change the elution conditions in said second column in order to adjust the difference in the retention times for the impurities and the product of interest so that they are no longer an integer multiple of the injection frequency, for example.

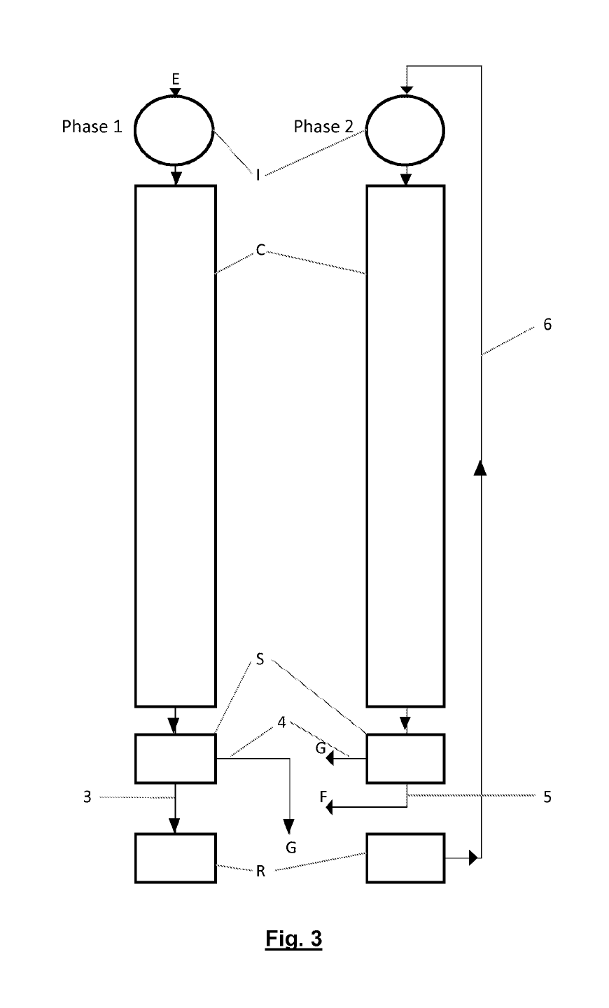

FIG. 3 shows a variant of the method wherein the first column and the second column are the same.

In this case (I), denotes the injector, which injects the mixture to be separated in accordance with time A (phase 1) and then B (phase 2) between injections, wherein the variations in time are determined, as before, by a defined protocol (protocol 1) during phase 1 and then by a second protocol (protocol 2) during phase 2.
(C) denotes the chromatography column, in which the separation of the product of interest is effected.
(S) denotes the decanting device, which collects the fractions of interest from column (C) according to protocol 1 during phase 1 and then according to protocol 2 during phase 2 (1), the factions being directed to the reservoir during the first phase (3) and to the collector of the purified fraction during phase 2 (5).
Outside of the periods in which the product of interest is eluted, the solvent stream containing the impurities to be eliminated (4) is directed towards the collector of fractions that cannot be used.
The arrows represent the flow of solvent.
Point (E) denotes the entry of the mixture to be purified, point (F) denotes the collection location of the purified fraction, point (G) denotes the collector for fractions that cannot be used and (R) denotes the reservoir containing the mixture of fractions of interest decanted during the first phase, which supplies the injector during phase 2 (6).

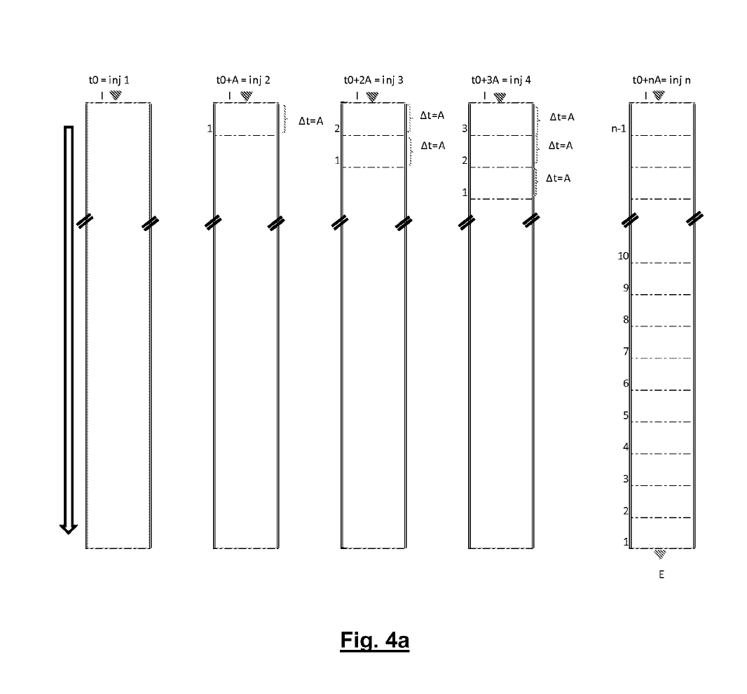

FIGS. 4a and 4b show the content of the first chromatography column at different times from instant t0 to t0+nA, where t0 represents the time when the first injection took place and n represents the number of injections that need to be carried out in order to inject the entire mixture to be separated into the column. A denotes the time intervals between two injections.

FIG. 4a shows that the variant according to which A is fixed over time. FIG. 4b shows a variant according to which A is not fixed over time and is determined for each injection by a protocol that is common to both injections and decanting operations.
The vertical arrow on the left represents the flow of solvent in the column.
(I) represents the site of injection into the column, and (E) elution site.
The dotted lines numbered (1) to (n-1) represent the product of interest during migration thereof in the column. It will be noted in these figures that another injection of mixture to purify takes place after each injection separated by interval A, wherein the injection is carried out without waiting for the product of interest included in the previous injection to be eluted from the column, or even separated from an impurity during migration.

It is thus possible to begin the migration of multiple quanta of the mixture to be separated at the same time in the same column with a constant interval of Δt=A for FIG. 4a and variable intervals Δt in FIG. 4b.

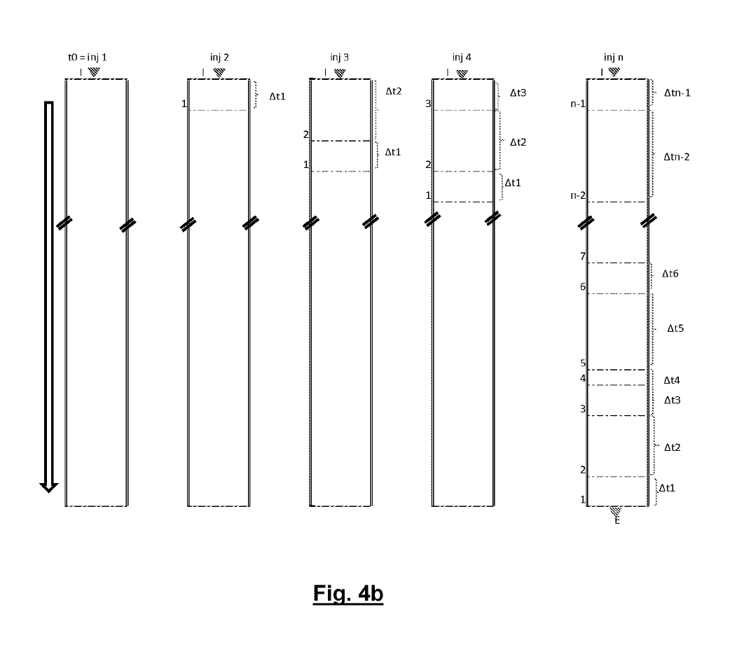

FIG. 5 shows the content of the second chromatography column at different times from T0 to T0+n′B, where (T0) represents the time when the first injection takes place and (n′) represents the number of injections that must be carried out in order to inject all of the fractions of interest obtained previously into the column. B denotes the time intervals between two injections, in the illustration of this variant, these are defined by a protocol that determines B as a fixed value over time.
The vertical arrow on the left represents the flow of solvent in the column.
(I′) represents the site of injection into the column, and (E′) represents the elution site.
The dotted lines numbered (1) to (n′-1) represent the product of interest during migration thereof in the column. It will be noted in this figure that another injection of mixture to purify takes place after each injection separated by interval B, wherein the injection is carried out without waiting for the product of interest included in the previous injection to be eluted from the column.
It is thus possible to begin the migration of multiple quanta of the mixture to be separated at the same time in the same column with a constant interval of Δt=B (for a protocol that sets B as constant over time) or a variable interval (for a protocol that sets different values for Δt at each instant).

In these embodiments shown in FIG. 4a, purification is effected due to the fact that the impurities that are co-eluted with the product of interest every A minutes during the first phase are no longer decanted at the same time as the product of interest in a second phase (for example the phase shown in FIG. 5). The frequencies of injection and collection of the fractions of interest differ from one phase to another (different protocols 1 and 2):

Thus, the product of interest to isolate or purify is eluted at the output of the first column at retention times (tr) of the product, then tr+A min, tr+2A min, tr+3A min . . . tr+nA min.

By collecting only the fractions of interest with a periodicity A, a large amount of the impurities is eliminated from the mixture. At this stage of the process only those impurities that were included in the previous or subsequent injection are still mixed with the collected product of interest. These impurities have retention times that have enabled them to be eluted during a phase of decanting fractions of interest, that is to say a multiple of A minutes since the retention time of the product of interest.

By injecting said collection of eluates in the same column every B minutes (with B having a value that differs from A and is not a multiple of A), the impurities that co-eluted with the products interest in the first phase are eliminated.

In fact, in this second phase impurities are still migrating with tr equivalent to tr+A min, tr+2A min, . . . tr+nA min, but the product of interest to be isolated or purified is eluted at product retention times tr, then tr+B min, tr+2B, tr+3B min . . . tr+nB min.

Decanting no longer takes place at the same times for the impurities: eluted at tr+A min, tr+2A min, tr+3A min, . . . tr+nA min; and for the product of interest eluted at tr+B min, tr+2B min, . . . tr+n′B min. This consequently induces an offset between the elution peaks of the impurities and the products of interest.

The purification obtained by this method and illustrated in this variant is guaranteed by changing the frequency of injections between the second and first phases of the method.

Another variant of this method, shown in FIG. 4b, is to make injections wherein interval A is not constant within the same phase, A may thus take several values Δt. The variations in A follow a program of variations in the value of Δt common to the injection and decanting stages in the same phase (protocol 1).

It may be seen from this figure that A successively takes the values Δt1, Δt2, Δt3, and so on. In this case, decanting takes place in accordance with the successive time intervals Δt1, Δt2, Δt3, and so on.

In this case purification is achieved in this case by changing the protocol between phase 1 (protocol 1) and phase 2 (protocol 2).

Another variant, which is not shown in the figures, consists in placing one or more detectors in parallel or in series with the decanting devices.

The device according to the invention and said variations thus make it possible to inject the mixture to be separated into the same column n times every A minutes without having to wait for the product of interest to be eluted.

The benefit of this invention is that it can be used to separate components of a mixture effectively and on a large scale by multiplying the yield from a single column by several factors. In fact, the invention makes it possible to inject the mixture to be separated into a chromatography column very many times even before elution of the product of interest begins, without having to wait for effective separation of impurities resulting from other injections.

With this method, it is possible to achieve very high chromatography performance with substantially more modest equipment and investment, limit the use of solvent, the elimination of which is often expensive as well, and limit the cost of scale-up studies.

### EXAMPLE

In this example, which serves purely to illustrate one of several possible embodiments of a method according to the invention, we will limit ourselves to an explanation of the method when it is applied to liquid chromatography in a chromatography column. The figures used to illustrate this example only reference the steps cited in the example, they are only present for exemplary purposes and are not limiting.

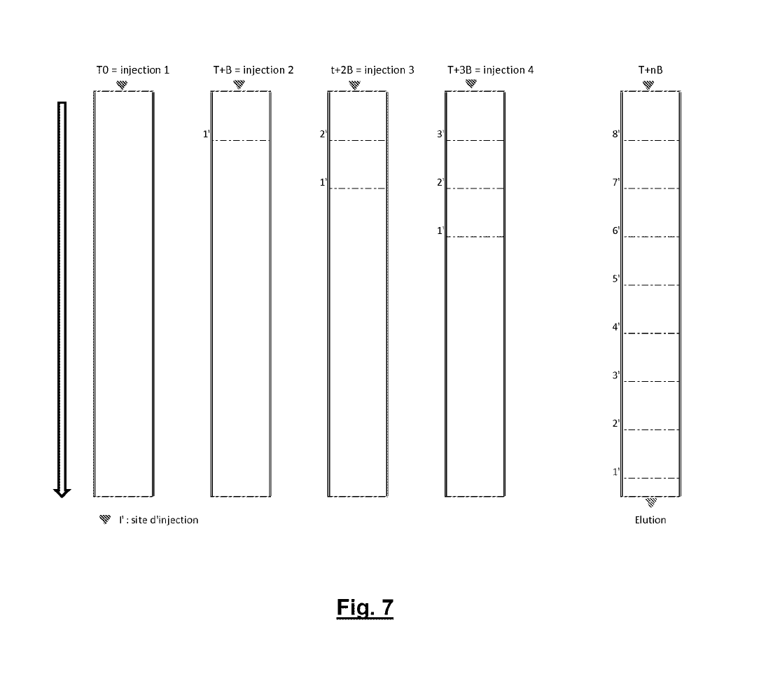

FIG. 8 shows a part of the chromatogram of the mixture to be separated.

For exemplary purposes, here we will consider the separation of a mixture from which it is desired to purify a product of interest (X) from its impurities, which include (Y1), (Y2) and (Y3) (FIG. 8). The retention time of product (X) of interest is 44 min, that of (Y1) is 41 min, that of (Y2) is 48.5 min, and that of (Y3) is 54.5 min.

For the purposes of the present example we will consider protocols according to which A and B are fixed for the duration of the process, wherein A=3 min and B=5 min, and we will use the same column in the two main sequences of the process for ease of understanding.

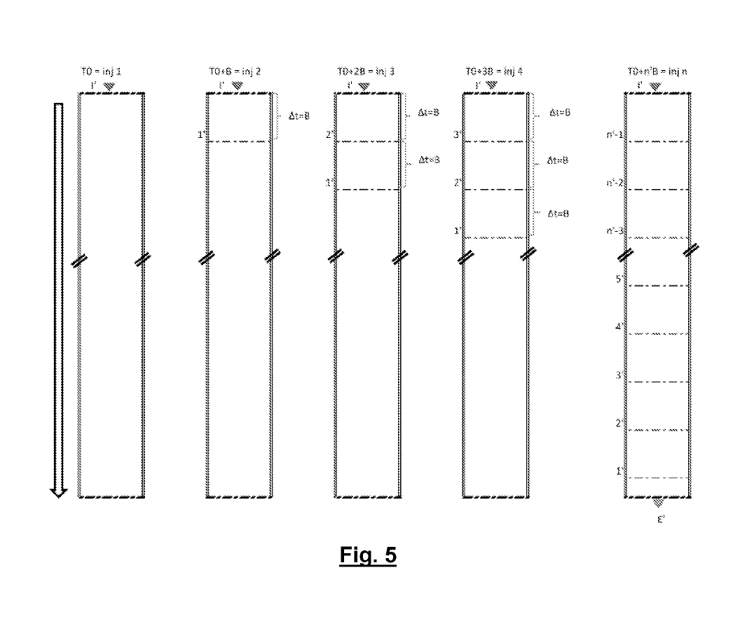

Phase 1: (FIG. 6) at time t0, a portion of the mixture to be separated is injected at point (I) of the column, in which the solvent flow is indicated by the vertical arrow on the left. At time t0+A, that is to say 3 minutes later in our example, we inject a second portion of the mixture to be separated in the same way. This injection takes place at the same point (I) as before.

At time t0+2A, that is to say after another 3 minutes in our example, and consequently 6 minutes after the process was started, we inject a third portion of the mixture to be separated in the same way. This injection always occurs at the same point (I) as before.

These injections are thus repeated at the same frequency of 3 minutes (protocol 1: A is fixed for the duration) until all of the mixture to be separated is used up. Injection is always carried out at the same place and the conditions of solvent, temperature, flow or other factors that are usually modified are not changed.

It should be noted that at time t=42 min the column contains 14 fractions of the mixture to be separated during migration.

The figure shows the positions of these fractions of the product of interest as they migrate in the column: numbered from 1 to 14.

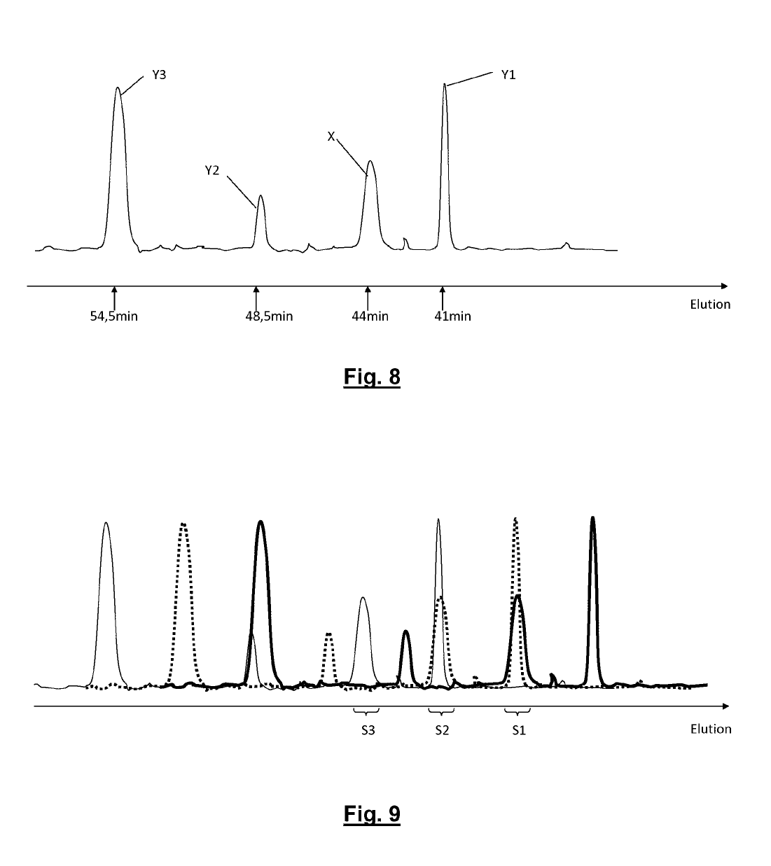

Starting from the 44th minute, the retention time of the product of interest, the product will be eluted every 3 minutes. FIG. 9 shows the superposition of the first three chromatograms of the co-migrating mixture in the same column with a time lag of 3 minutes (period A prescribed by protocol 1), the bold curve represents the chromatogram obtained by the injection of the first unit fraction of the mixture. The dotted curve represents the chromatogram 3 minutes later, this corresponds to the injection of the second unit fraction of the mixture, and the unbroken curve represents the chromatogram corresponding to the injection of the third unit fraction of the mixture to be separated.

The eluate collection device serves to collect the eluate from the column every 3 minutes starting from the retention time of the product of interest. This is a device for collecting fractions that decants the faction of interest according to the same protocol followed by injections, in this case at times tr, tr+3 min, tr+2×3 min, tr+3×3 min until tr+n×3. Outside these periods in which the device collects the fraction of interest, the solvent flow is directed to a collection tank for eluates that are not reusable.

(S1), (S2) and (S3) (FIG. 9) represent the decanting periods of the fraction of interest, they take place every A minutes and thus, in this case, every 3 minutes, in this case mostly Y1.

Impurities Y2 and Y3, which have differences in retention times from that of the product of interest that are not integer multiples of 3 minutes (the injection frequency) are not decanted during the decanting sequences (S).

However, it should be noted that impurity Y1 is co-eluted with the product of interest to the extent that its retention time is the same as product of interest X less A=3 minutes (44 minutes−3 minutes=41 minutes).

The collection of the fractions of interest results in the formation of a mixture containing the product of interest with the impurities having a difference from the retention time of the product of interest that is an integer multiple of 3 minutes.

In our example the recovered eluate contains:
product X injected at t0,
product X injected at t1 and impurities originating from the first injection with a tr=44 +/−3 minutes
product X injected at t2, the impurities originating from the first injection with a tr=44+6 minutes, and the impurities originating from the first injection with a tr=44 +3 minutes, . . .
And so on.
   Where t1=t0+3 min, t2=t0+6 min . . . tn=t0+n3 min.

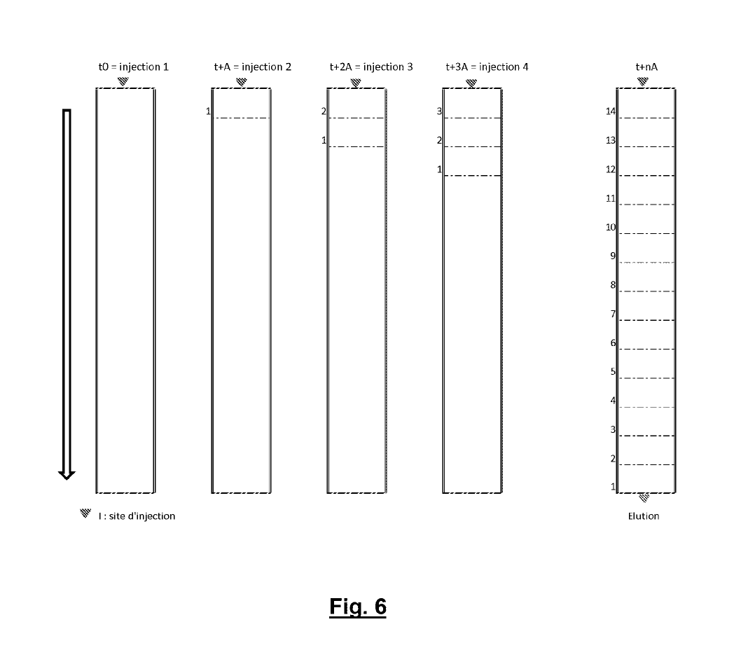

By re-injecting this mixture and modifying the injection and collection intervals (B is set to 5 minutes and constant in our example: this is protocol 2) in a second part of the device, it is possible to remove these impurities: FIG. 7.

Phase 2 (shown in FIG. 7) at time T0, a part of the mixture obtained previously is injected at point (I′) of the column with the solvent flow indicated by the vertical arrow on the left.

At time T0+B, that is to say 5 minutes later in our example, in the same way we inject a second portion of the mixture obtained at the end of phase 1. This injection takes place at the same point (I′) as before.

At time T0+2B, that is to say after another 5 minutes in our example and thus 10 minutes after starting the process, we inject a third portion of the mixture to be separated in the same way. This injection always takes place at the same point (I′) as before.

These injections are repeated successively in the same way with the same periodicity of 5 minutes until all the mixture obtained at the end of phase 1 is used up. The injection carried out at the same place and conditions of solvent, temperature, flow or other factors that are usually modified are not changed.

It should be noted that at time t=42 minutes the column contains 8 fractions of the mixture to be separated during migration.

The figure shows positions numbered from (1′) to (8′) of these fractions of the product of interest during migration in the column.

Starting from the 44th minute, the product of interest is eluted every 5 minutes (in our example retention time tr is effectively the same as before since we chose to keep the same column).

The eluate recovery device (similar to the preceding) enables the eluate to be recovered from the column in accordance with protocol 2, that is to say every 5 minutes starting from the retention time of the product of interest. It is a device that follows protocol 2 (B is fixed for the duration) for collecting fractions for decanting the fraction of interest at times tr, tr+5 min, tr+2×5 min, tr+3×5 min until tr+n×5 min. Outside of these periods where the device recovers the fraction of interest, the solvent flow is directed to a collection tank for eluates that are not reusable.

This collection of fractions of interest results in the formation of a highly purified fraction of the product of interest.

In fact, the impurities that are co-eluted with product of interest during the first phase with a tr of a multiple of 3 minutes are no longer recovered at the same time as the product of interest in the second phase since this is eluted every 5 minutes. Thus, impurity Y1 migrating with a tr of 41 minutes, is eluted at 41 min, then at 46 min, 51 min, 56 min, and so on. Whereas product of interest X is collected at 44 minutes, then at 49 minutes, 54 minutes, 59 minutes.

The collection of the fractions of interest results in production of the purified product.

The only impurities that may possibly persist are those having a retention time=tr of the product of interest +/−n×3×5 minutes, that is to say impurities that migrate with a tr of 44+/−15 minutes, 44 +/−30 minutes and so on.

In our example no impurity migrates at these retention times, however if such were the case they could be eliminated by an additional step of this process with an injection interval of 7 minutes, for example.

It may be noted in this example that by implementing two phases it is possible to migrate 8 times more mixture to be separated into the column than it would tolerate conventionally at the same time.

An embodiment of the invention creates a simple method for separating fractions of a mixture. In its basic embodiment, the method does not necessarily require the use of gradients, nor the shifting of injection points, nor any changes in the flow directions of the solvent, nor waiting more than a few minutes between two injections.

In particular, with an embodiment of said invention it is possible to use smaller columns, obtain increased outputs therefrom, limit the adjustments to the eluent systems used, and limit solvent consumption. Many other advantages will become apparent upon reading the remainder of this document.

Although the present disclosure has been described with reference to one or more examples, workers skilled in the art will recognize that changes may be made in form and detail without departing from the scope of the disclosure and/or the appended claims.

1. A method for separating fractions of a mixture to be separated by liquid chromatography, comprising:
multiple injections of the mixture to be separated, wherein the injections are made successively into a chromatography column after time intervals A,
multiple decanting operations, wherein the fractions of said column are decanted successively after time intervals A, generating an eluate enriched with the fraction of interest, which is created from at least one of said decanted fractions,
multiple injections of the eluate generated in the decanting operations, wherein the injections of the eluate are carried out successively after time intervals B into a second chromatography column, and
multiple decanting operations, wherein the fractions from said second column are decanted successively after time intervals B.

2. The method for separating according to claim 1, wherein the injections of the mixture into a column may be made before first elutions of the fractions of interest are made from the same column.

3. The method for separating according to claim 1, wherein the injections of the mixture into a column may be made without obtaining separation with chromatograms resulting from preceding injections.

4. The method for separating according to claim 1, wherein A and/or B remains constant over time.

5. The method for separating according to claim 1, wherein A and/or B vary over time.

6. The method for separating according to claim 1, wherein A and/or B are determined such that they are not integer multiples of one another.

7. The method for separating according to claim 1, wherein the second column is the same as the first column.

8. The method for separating according to claim 1, comprising a step of concentrating the generated eluate before continuing to the steps of multiple injections of the eluate into said second chromatography column.

9. The method for separating according to claim 1, wherein the-elution systems employed in the second column are different from those used in the first column.

10. The method for separating according to claim 1, wherein the injection of the mixture to be separated is cyclical.

11. The method for separating according to claim 1, wherein at least one of the fractions of the mixture comprises a product that is to be eliminated from the mixture.

12. The method for separating according to claim 1, wherein the columns are replaced by one or more assemblies of multiple columns.

13. The method for separating according to claim 1, wherein a detector is added in parallel or in series with the decanting device.

14. The method for separating according to claim 1, wherein the second column has a cross section that is approximately equal to a significant multiple of a cross section of the first column.

15. A device for separating fractions of a mixture, wherein the device comprises:
at least one chromatography column;
means for decanting a plurality of fractions from said chromatography column at controlled time intervals A and/or B, generating an eluate enriched with the fraction of interest, which is created from at least one of said decanted fractions;
means for injecting a mixture into said chromatography column at controlled time intervals A and/or B, and/or injecting said eluate generated from at least one of said decanted fractions;
means for collecting said plurality of decanted fractions from said chromatography column; and
means for transferring said decanted fractions from said means for collecting to said means for injecting.
